(19) United States
(12) Patent Application Publication
(10) Pub. No.: US 2015/0112843 A1
(43) Pub. Date: Apr. 23, 2015

(54) SUBSTITUTION OF WORK PRODUCTS

(71) Applicant: International Business Machines Corporation, Armonk, NY (US)

(72) Inventors: Florian Pinel, New York, NY (US); Lav R. Varshney, Yorktown Heights, NY (US)

(73) Assignee: International Business Machines Corporation, Armonk, NY (US)

(21) Appl. No.: 14/269,353

(22) Filed: May 5, 2014

Related U.S. Application Data
(60) Provisional application No. 61/892,000, filed on Oct. 17, 2013.

(51) Int. Cl. G06Q 10/08

(52) U.S. Cl. CPC G06Q 10/0875
USPC 705/29

(57) ABSTRACT

A method comprises the steps of analyzing a given work product to determine one or more constituents used in the given work product, determining a given work product profile associated with the given work product based at least in part on the one or more constituents used in the given work product, comparing the given work product profile with one or more other work product profiles to determine a subset of the one or more other work product profiles similar to the given work product profile, and selecting one or more substitute work products having respective work profiles in the subset as substitutes for the given work product. The analyzing, determining, comparing and selecting steps are performed by at least one processor device.

### CROSS-REFERENCE TO RELATED APPLICATIONS

The present application claims the benefit of U.S. Provisional Application No. 61/892,000, filed Oct. 17, 2013, the disclosure of which is incorporated by reference herein.

### FIELD

The field relates to computational creativity and, more particular to techniques for generation of work products.

### BACKGROUND

Various types of work products are made using a set of constituents. As an example, a recipe is a type of work product that utilizes a set of ingredients to make a particular food dish. Businesses and other entities often have a set of work products which are offered for sale or used within an entity. Due to various issues, the use of an existing work product may become undesirable. For example, a restaurant may have a set menu and have various relationships with suppliers to receive the ingredients used in the recipes for the set menu. In response to various external or internal constraints, the restaurant may desire to alter the set menu without wasting inventory of a given set of ingredients or disrupting a supply chain for the set of ingredients. Thus, new recipes must be found which utilize the set of ingredients.

### SUMMARY

According to one embodiment of the invention, a method comprises the steps of analyzing a given work product to determine one or more constituents used in the given work product, determining a given work product profile associated with the given work product based at least in part on the one or more constituents used in the given work product, comparing the given work product profile with one or more other work product profiles to determine a subset of the one or more other work product profiles similar to the given work product profile, and selecting one or more substitute work products having respective work profiles in the subset as substitutes for the given work product. The analyzing, determining, comparing and selecting steps are performed by at least one processor device.

According to another embodiment of the invention, an article of manufacture comprises a computer readable storage medium for storing computer readable program code. The computer readable program code, when executed, causes a computer to analyze a given work product to determine one or more constituents used in the given work product, determine a given work product profile associated with the given work product based at least in part on the one or more constituents used in the given work product, compare the given work product profile with one or more other work product profiles to determine a subset of the one or more other work product profiles, similar to the given work product profile, and select one or more substitute work products having respective work profiles in the subset as substitutes for the given work product.

According to another embodiment of the invention, an apparatus comprises a memory and a processor device operatively coupled to the memory. The processor device is configured to analyze a given work product to determine one or more constituents used in the given work product, to determine a given work product profile associated with the given work product based at least in part on the one or more constituents used in the given work product, to compare the given work product profile with one or more other work product profiles to determine a subset of the one or more other work product profiles similar to the given work product profile, and to select one or more substitute work products having respective work profiles in the subset as substitutes for the given work product.

These and other embodiments of the invention will become apparent from the following detailed description of illustrative embodiments thereof, which is to be read in connection with the accompanying drawings.

### BRIEF DESCRIPTION OF THE DRAWINGS

FIG. 1 illustrates a system for work product substitution, according to an embodiment of the invention.

FIG. 2 illustrates a system for recipe substitution, according to an embodiment of the invention.

FIG. 3 illustrates a system for itinerary substitution, according to an embodiment of the invention.

FIG. 4 illustrates an example of constituent classification, according to an embodiment of the invention.

FIG. 5 illustrates an example of recipe ingredient classification, according to an embodiment of the invention.

FIG. 6 illustrates an example of itinerary event classification, according to an embodiment of the invention.

FIG. 7 illustrates an example of work product classification, according to an embodiment of the invention.

FIG. 8 illustrates an example of recipe classification, according to an embodiment of the invention.

FIG. 9 illustrates an example of itinerary classification, according to an embodiment of the invention.

FIG. 10 illustrates a methodology for work product substitution, according to an embodiment of the invention.

FIG. 11 illustrates a methodology of a portion of work product substitution, according to an embodiment of the invention.

FIG. 12 illustrates an example of work product profile matching, according to an embodiment of the invention.

FIG. 13 illustrates an example of a recipe dish profile and work product matching, according to an embodiment of the invention.

FIG. 14 illustrates a computing device in accordance with which one or more components/steps of techniques of the invention may be implemented, according to an embodiment of the invention.

### DETAILED DESCRIPTION

Illustrative embodiments of the invention may be described herein in the context of illustrative methods, systems and devices for work product substitution. However, it is to be understood that embodiments of the invention are not limited to the illustrative methods, systems and devices described but instead are more broadly applicable to other suitable methods, systems and devices.

As used herein, the term “work product” is used to refer to a material or abstract object. Work products include manufactured goods such as electronic circuits, food products, and pharmaceuticals, as well as culinary recipes, complex travel itineraries, and financial portfolios. Some work products are also work plans, in that they include a process that realizes another work product. For example, a culinary recipe is both a work product and a work plan for creating another work product, namely, a food dish.

Embodiments of the invention provide systems, devices and methods which allow for dynamic substitution of work products. In some embodiments, a substitute for a given work product is selected such that constituents used in the substitute work product are similar to those of the existing work product. The substitute work product may also use a superset of the constituents used in the existing work product, or in some instances a subset of the constituents used in the existing work product. In some instances, a single existing work product may be substituted by two work products, with each of the two substitute work products using respective different subsets of the constituents used in the existing work product.

FIG. 1 illustrates a system 100 for work product substitution. The system 100 includes an assessor module 102, matching module 104, designer module 106, evaluator module 108 and domain knowledge database 110. Each of the assessor module 102, matching module 104, designer module 106 and evaluator module may be implemented using hardware, software or a combination of hardware and software running on one or more computing or other processing devices.

As shown in FIG. 1, the assessor module 102, matching module 104, designer module 106 and evaluator module 108 are connected to the domain knowledge database 110. Each of these modules is configured to query or otherwise exchange information with the domain knowledge database 110.

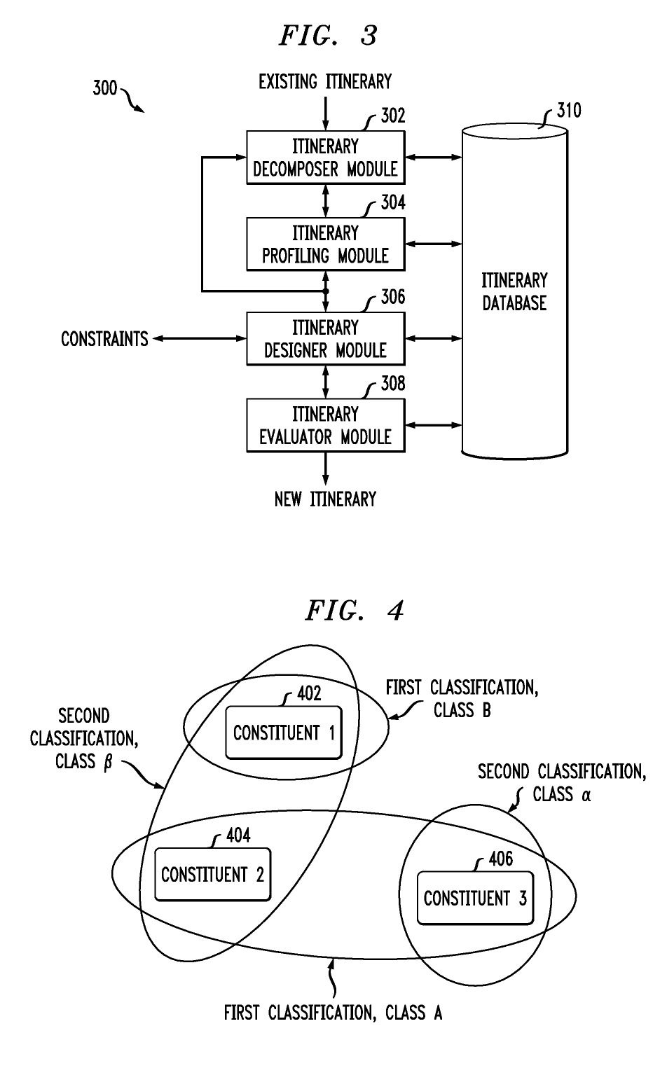

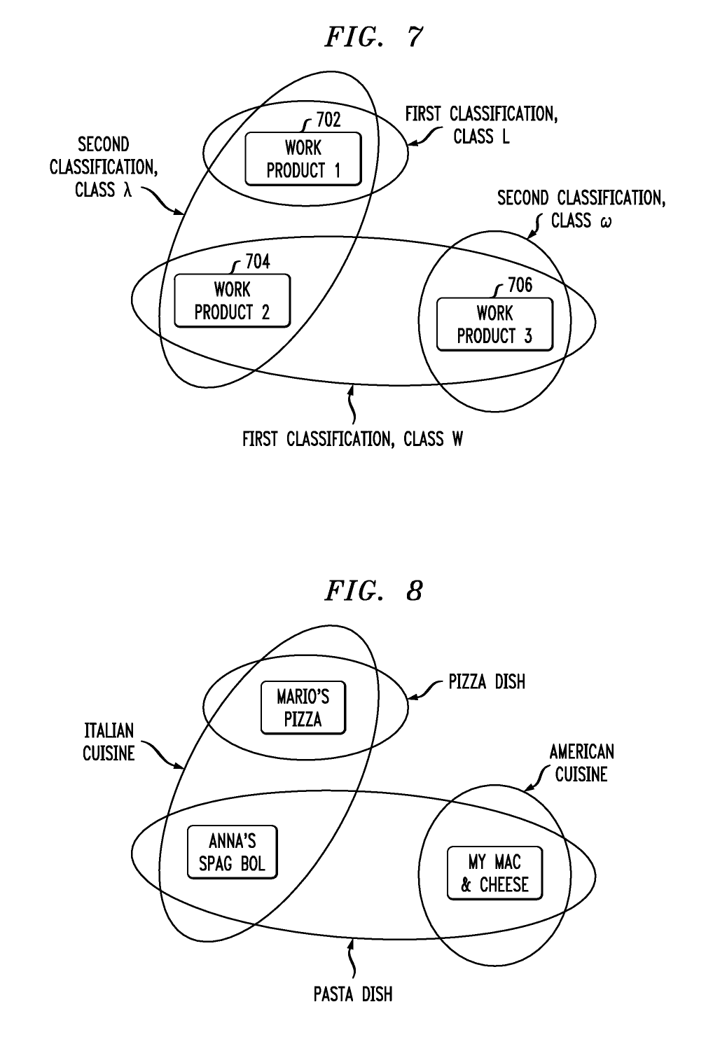

The domain knowledge database 110 stores information relating to existing work products. This information may include lists of constituents in existing work products, statistical analysis of clusters of work products and constituents, user evaluation and feedback information for work products, etc. Examples of clustering and information storage in the domain knowledge database will be discussed in further detail below with respect to FIGS. 4 and 7.

The assessor module 102 is configured to receive an existing work product, or information characterizing an existing work product. For example, the assessor module 102 may not receive a physical object but instead receive an identification of a physical object or other work product.

The assessor module 102 analyzes the existing work product to determine a set of constituents used in the work product. The assessor module 102 provides the list of constituents to matching module 104 and designer module 106.

Matching module 104 receives the set of constituents used in the existing work product to determine a work product profile. The matching module 104 may determine constituent classifications for each constituent used in the existing work product. The matching module 104 may query the domain knowledge database 110 with the set of constituent classifications to determine one or more work product profiles with similar constituent classifications. Based on a comparison of the constituent classifications used in the existing work product and constituent classifications of a set of work product profiles, the matching module 104 determines a work product profile of the existing work product. Examples of techniques which may be utilized to match work product profiles will be discussed in further detail below. The matching module 104 provides the determined work product profile to the designer module 106.

Designer module 106 receives the set of constituents used in the existing work product from the assessor module 102 and the determined work product profile for the existing work product from the matching module 104. The designer module 106 may further receive information relating to one or more constraints for use in selecting substitute work products. Designer module 106 uses information stored in the domain knowledge database 110 to determine a set of possible substitute work products. The designer module 106 may determine a subset of work product profiles which are similar to the work product profile of the existing work product, or create novel work products that belong to the subset of work product profiles. The designer module 106 selects one or more work products in the subset of work product profiles as possible substitute work products. The possible substitute work products may be referred to herein as candidate work products. The designer module 106 provides one or more candidate work products to the evaluator module 108.

Evaluator module 108 receives one or more candidate work products from the designer module 108. The evaluator module 108 determines which of the candidate work products to select as a substitute work product. The evaluator module 108 may query the domain knowledge database 110 and/or one or more users for feedback relating to the candidate work products. For example, the evaluator module 108 may provide a list of candidate work products to a user, and select the substitute work product based on the user's input. The evaluator module 108 may also receive one or more constraints which are utilized for selecting one of the candidate work products as the substitute work products. The constraints supplied to the evaluator module 108 may be the same as or different from the constraints supplied to the designer module 106.

The evaluator module 108 then provides the substitute work product as the new work product. It is important to note, however, that the use of the term “new” does not necessarily require that the substitute work product be completely novel. Instead, in some instances the new work product may simply be a different existing work product. In other instances, the new work product may be a modified existing work product or a completely new work product.

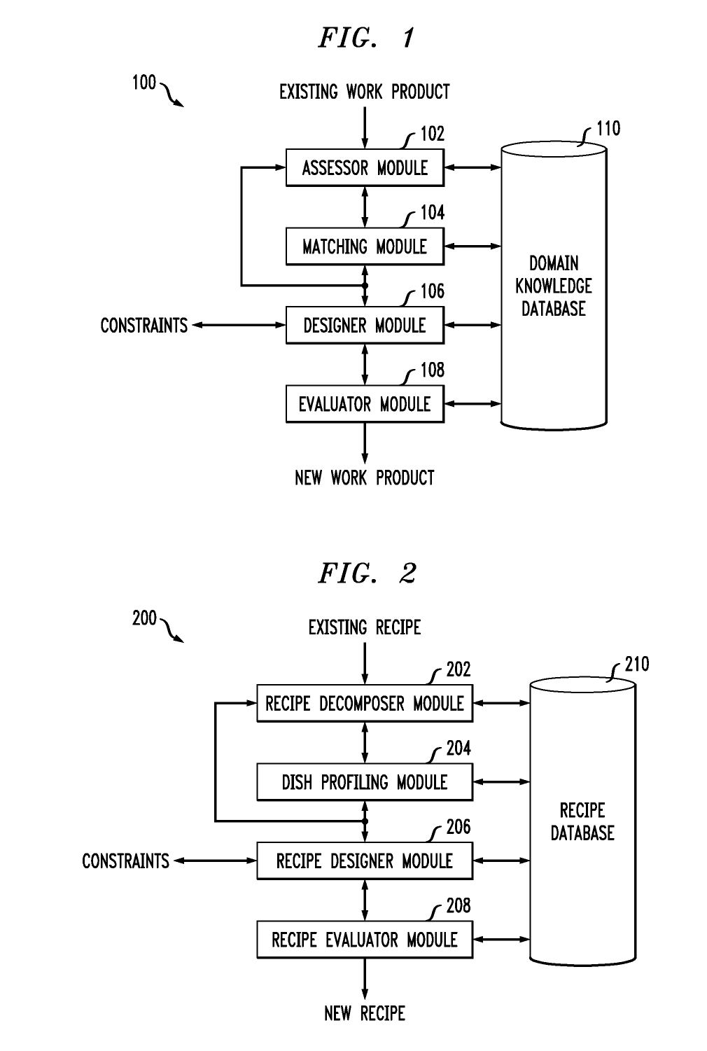

FIG. 2 illustrates a system 200 for recipe substitution. System 200 includes recipe decomposer module 202, dish profiling module 204, recipe designer module 206, recipe evaluator module 208 and recipe database 210. The recipe decomposer module 202, dish profiling module 204, recipe designer module 206, recipe evaluator module 208 and recipe database 210 perform functionality similar to that described above with respect to the assessor module 102, matching module 104, designer module 106, evaluator module 108 and domain knowledge database 110, respectively.

Recipe decomposer module 202 receives an existing recipe, and determines a set of ingredients used in the recipe. The recipe decomposer module 202 provides the set of ingredients to dish profiling module 204, which determines a dish profile which matches the set of ingredients in the existing recipe. For example, a list of ingredients which include pasta, ricotta cheese, mozzarella cheese, ground beef and tomato sauce can be matched to a “lasagna” dish profile. The dish profiling module 204 may use information stored in the recipe database 210 to determine the dish profile which matches the set of ingredients used in the existing recipe.

The recipe designer module 206 receives a set of ingredients along with the dish profile for the existing recipe. The recipe designer module 206 may also receive one or more constraints for use in determining substitute recipes. Various types of constraints may be utilized, including by way of example constraints relating to user preferences or food trends, particular ingredients which should or should not be included in a substitute recipe, particular ingredients which should or should not be paired with other ingredients, information relating to food-borne illness outbreaks, information relating to scandals, or other news stories regarding particular types of dishes, etc.

For example, a constraint may be that frozen lasagna from one or more manufacturers of frozen food products are subject to recall, leading to a decrease in overall consumption of lasagna as consumers fear that other lasagna products (even those not directly affected by a particular recall) are similarly corrupted and thus should be avoided. As such, a restaurant which serves lasagna may desire to at least temporarily find a substitute recipe to use. The restaurant, however, may have a large inventory of the ingredients used in lasagna or may have existing supply chain commitments related to the purchase of ingredients used in lasagna. Thus, the restaurant may benefit from substituting lasagna on the menu with a different food dish that uses similar ingredients. Thus, embodiments allow manufacturers or other entities to react faster to trends and preference shifts without having to significantly alter their supply chain. Embodiments also allow for food industry actors to maintain consumer confidence by dynamically adjusting to health scares.

Various other types of constraints may be utilized in addition to those described above. For example, a restaurant may have a signature style dish or culinary identity, and thus desire that new recipes fit the signature style or identity. As another example, a restaurant that serves primarily a certain type of cuisine, such as Italian cuisine, may have a constraint that substitute recipes also be Italian cuisine. As another example, a constraint may be that a restaurant seeks to vary its existing menu, even if no particular ingredient or dish is subject to another constraint. Thus, the constraint may specify a novelty level or surprise level for a replacement recipe. As such, embodiments allow for restaurants or other types of entities to create and replace existing work products with new work products to keep customers interested.

It is important to note that embodiments are not limited solely to use by restaurant owners. Instead, various other entities, such as bakeries, food manufacturers, food suppliers, groceries, supermarkets, households, etc. may also use techniques described herein for selecting substitute recipes. It is also important to note that the various constraints described above are not restricted solely to the context of selecting substitute recipes. Instead, such constraints may be utilized or adapted for other contexts, including by way of example itinerary substitution as will be described below with respect to FIG. 3.

The recipe designer module 206 uses the constraints, ingredient list and dish profile to determine a subset of dish profiles which match the dish profile of the existing recipe. The recipe designer module 206 may utilize information stored in the recipe database 210 for making this determination. The recipe designer module 206 can select one or more substitute recipes or dishes in the subset of dish profiles as candidates for the substitute recipe, or create a novel recipe belonging to a dish profile in the subset.

Recipe evaluator module 208 receives the one or more candidate recipes, and uses feedback information stored in recipe database 210 and/or user input to select one of the candidate recipes as the new recipe. The recipe evaluator module 208 may also receive a set of constraints, which may be the same as or different from the constraints supplied to the recipe designer module 206. Again, it is important to note that the use of the term “new” to describe the substitute recipe does not require that the substitute recipe be entirely novel. Instead, the new recipe selected as the substitute may be an existing recipe in the recipe database 210 or a modified version of an existing recipe in the recipe database 210. In some instances, however, the new recipe may be a novel recipe different from existing recipes in the recipe database 210.

FIG. 3 illustrates a system 300 for itinerary substitution. The system 300 includes itinerary decomposer module 302, itinerary profiling module 304, itinerary designer module 306, itinerary evaluator module 308 and itinerary database 310. The itinerary decomposer module 302, itinerary profiling module 304, itinerary designer module 306, itinerary evaluator module 308 and itinerary database 310 perform functionality similar to that described above with respect to the assessor module 102, matching module 104, designer module 106, evaluator module 108 and domain knowledge database 110, respectively.

Itinerary decomposer module 302 receives an existing itinerary, and determines a set of events used in the itinerary. For example, the itinerary may be a travel itinerary and the events may be monuments, parks, museums, restaurants, transportation, etc. in the itinerary. The itinerary decomposer module 302 provides the set of events to itinerary profiling module 304, which determines an itinerary profile which matches the set of events in the existing itinerary. For example, a list of events which includes a camping in a national park, hiking to a river, and kayaking the river to a destination may be matched to an “adventure” itinerary profile. The itinerary profiling module 304 may use information stored in the itinerary database 310 to determine the itinerary profile which matches the set of events in the existing itinerary.

The itinerary designer module 306 receives the set of events along with the itinerary profile for the existing itinerary. The itinerary designer module 306 may also receive one or more constraints for use in determining substitute itineraries. Various types of constraints may be utilized, including constraints relating to user preferences or travel trends, particular events which must be included or excluded in a substitute itinerary, events which conflict with or are complementary to one another and thus should or should not be paired in a substitute itinerary, information relating to closures or cancellations of events and activities due to weather or security concerns, etc.

As an example, a constraint may be that an itinerary designer wishes to create additional itineraries having a given profile which share existing travel partners. An itinerary designer may wish to do so to give customers additional choices, to keep up with new trends, etc. For example, a kayaking itinerary may belong to a “river adventure” profile. The kayaking itinerary may involve camping in a national park, hiking to a river, renting a kayak, and kayaking the river. A substitute itinerary may be a river fishing itinerary. The river fishing itinerary may include the events of camping in a national park and hiking to the river. The river fishing itinerary, however, may replace the renting a kayak event with renting fishing equipment or visiting a tackle shop. The river fishing itinerary may further replace the kayaking event with river fishing and a riverside meal to cook the day's catch. Embodiments thus allow travel agencies or other entities to offer tours with predefined itineraries and customizable activities for customer profiles. A predefined itinerary may be adjusted to account for user preference by shifting the focus or interest type of a tour or maintaining the focus or interest type of a tour while substituting events in the tour.

The itinerary designer module 306 uses the constraints, event list and itinerary profile to determine a subset of itinerary profiles which match the itinerary profile of the existing itinerary. The itinerary designer module 306 may utilize information stored in the itinerary database 210 for making this determination. The itinerary designer module 306 can select one or more substitute itineraries in the subset of itinerary profiles as candidates for the substitute itinerary, or create one or more novel itineraries belonging to one of the subset of itinerary profiles.

Itinerary evaluator module 308 receives the one or more candidate itineraries, and uses feedback information stored in itinerary database 310 and/or user input to select one of the candidate itineraries as the new itinerary. The itinerary module 308 may also receive a set of constraints, which may be the same as or different from the constraints supplied to the itinerary designer module 306. Once again, it is important to note that the use of the term “new” to describe the substitute itinerary does not require that the substitute itinerary be entirely novel. Instead, the new itinerary selected as the substitute may be an existing itinerary in the itinerary database 310 or a modified version of an existing itinerary in the itinerary database 310. In some instances, however, the new itinerary may be a novel itinerary different from existing itineraries in the itinerary database 310.

FIG. 4 illustrates an example of constituent classification in the domain knowledge database 110. Constituents may be clustered into categories using one or more dimensions. FIG. 4 shows three constituents which have respective first and second classifications or clusters. Constituent 1 402 has a first classification of class B and a second classification of class β, constituent 2 404 has a first classification of class A and a second classification of class β, and constituent 3 406 has a first classification of class A and a second classification of class α, Although shown in FIG. 4 as having two classifications, embodiments are not limited solely to constituents which have two classifications. Instead, some constituents may have more than two or only a single classification. In addition, classifications may comprise clusters of more than two constituents.

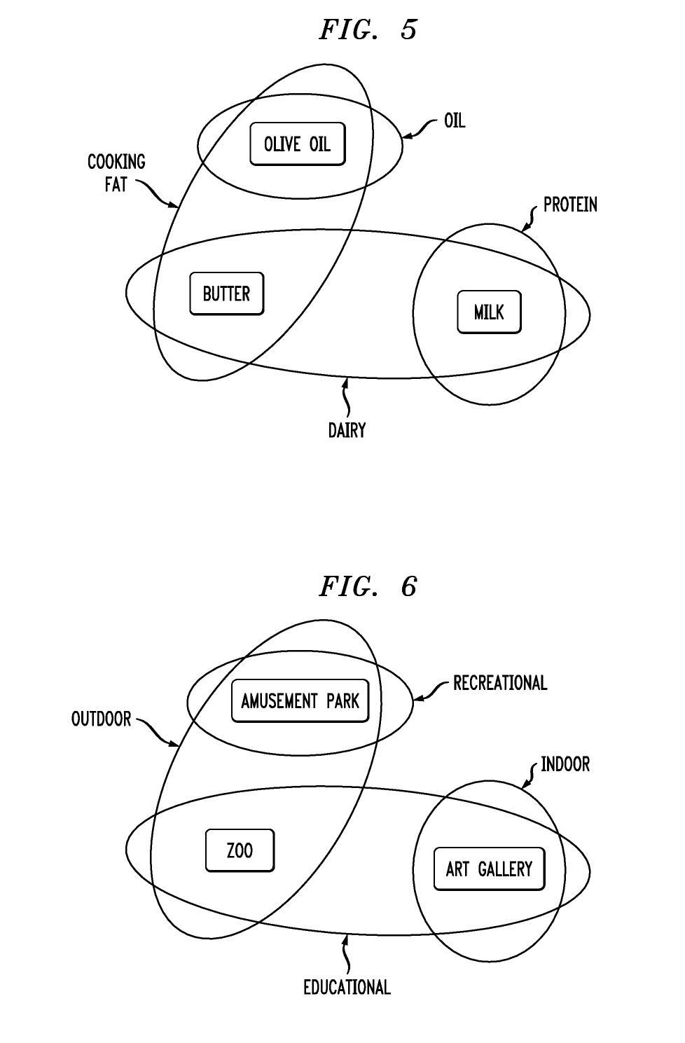

FIG. 5 illustrates an example of ingredient clustering in the recipe database 210. The ingredients of olive oil and butter have a first classification of “cooking fat.” Olive oil has a second classification of “oil” and butter has a second classification of “dairy.” Milk has a first classification of “protein” and a second classification of “dairy.” Thus, olive oil and butter form a “cooking fat” cluster and butter and milk form a “dairy” cluster.

FIG. 6 shows an example of itinerary event clustering in the itinerary database 310. The events amusement park and zoo are clustered as “outdoor” events. The amusement park event is also classified as a “recreational” event. The zoo and art gallery events are clustered as “educational” events. The art gallery event is also classified as an “indoor” event.

It is important to note that FIGS. 5 and 6 merely show examples of constituent clustering in the contexts for use in the contexts of recipe substitution and itinerary substitution, respectively. Embodiments, however, are not limited solely to use in the context of recipe or itinerary substitution. Instead, embodiments may be used for a wide variety of other types of work product substitution, such as fashion or outfit substitution or business process substitution.

FIG. 7 illustrates an example of work product clustering in the domain knowledge database 110. Work product 1 702 and work product 2 704 are clustered by their second classifications, class X. Work product 1 has a first classification of class L. Work product 2 and work product 3 706 are clustered by their first classifications, class W. Work product 3 has a second classification of class ω. Although shown in FIG. 7 as having two classifications, embodiments are not limited solely to work products which have two classifications. Instead, some work products may have more than two or only a single classification. In addition, classifications may comprise clusters of more than two work products.

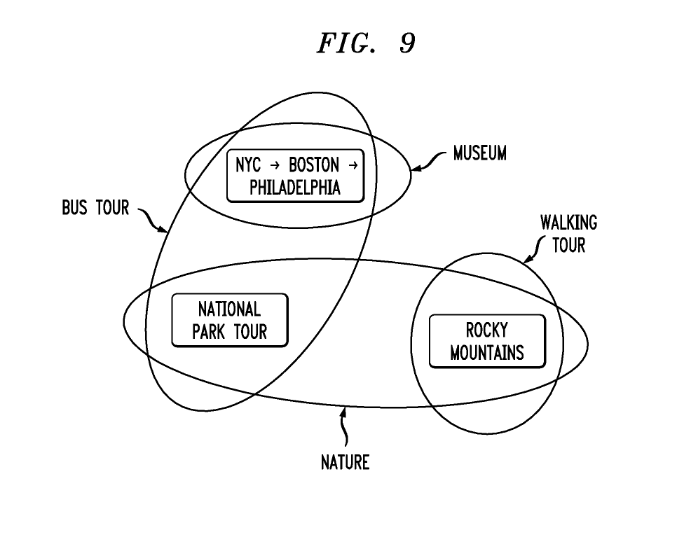

FIGS. 8 and 9 show two examples of work product clustering for the application areas of recipe substitution and itinerary substitution in the recipe database 210 and itinerary database 310, respectively. FIG. 8 shows three food dishes: Mario's Pizza, Anna's Spag Bol and My Mac & Cheese. Mario's Pizza has a first classification as a pizza dish and a second classification as Italian Cuisine. Anna's Spag Bol has a first classification as a pasta dish and a second classification as Italian Cuisine. My Mac & Cheese has a first classification as a pasta dish and a second classification as American Cuisine. Thus, Mario's Pizza and Anna's Spag Bol form a cluster under their second classification, Italian Cuisine, while Anna's Spag Bol and My Mac & Cheese form a cluster under their first classification, as pasta dishes.

FIG. 9 shows three events—a national park tour, the Rocky Mountains, and a tour of New York City (NYC), Boston and Philadelphia. The tour of NYC, Boston and Philadelphia is clustered with the national park tour as “bus tours.” The tour of NYC, Boston and Philadelphia is also classified as a museum tour. The national park tour and Rocky Mountains are clustered as “nature” events, and the Rocky Mountains event is also classified as a “walking tour.”

Again, it is important to note that the clustering work products shown in FIGS. 8 and 9 are presented by way of example only. Embodiments are not limited solely to substitution of recipes and itineraries, but are instead more broadly applicable to various other application areas.

In addition to clustering constituents and work products, the domain knowledge database 110 may contain other information relating to work products and constituents. For example, the domain knowledge database 110 may contain feedback or other historical data on quality assessments of work products including human hedonic perception data. The domain knowledge database 110 may further contain statistical analysis of work products and/or constituents as well as clusters or classifications of work products and/or constituents. The domain knowledge database 110 may also contain information relating to various characteristics of the constituents and/or work products for a given work profile. Such characteristics may include a frequency of occurrence of constituents in work products clustered in the given work product profile, constituents or constituent classes which are commonly paired with other constituents or constituent classes in work products clustered in the given work product profile, constituents or constituent classes which may not be paired with one another in the given work product profile, constituents or constituent classes which are deemed to be essential or required, constituents or constituent classes deemed to be optional, etc.

The domain knowledge database 110 may also contain other information relating to constituents and constituent classes, such as the cost or availability of constituents. In the context of recipe substitution, the recipe database 210 may include nutritional facts and chemical composition information for ingredients and recipes. In the context of itinerary substitution, the itinerary database may include information related to the hours or dates of availability of events, age restrictions for events, etc.

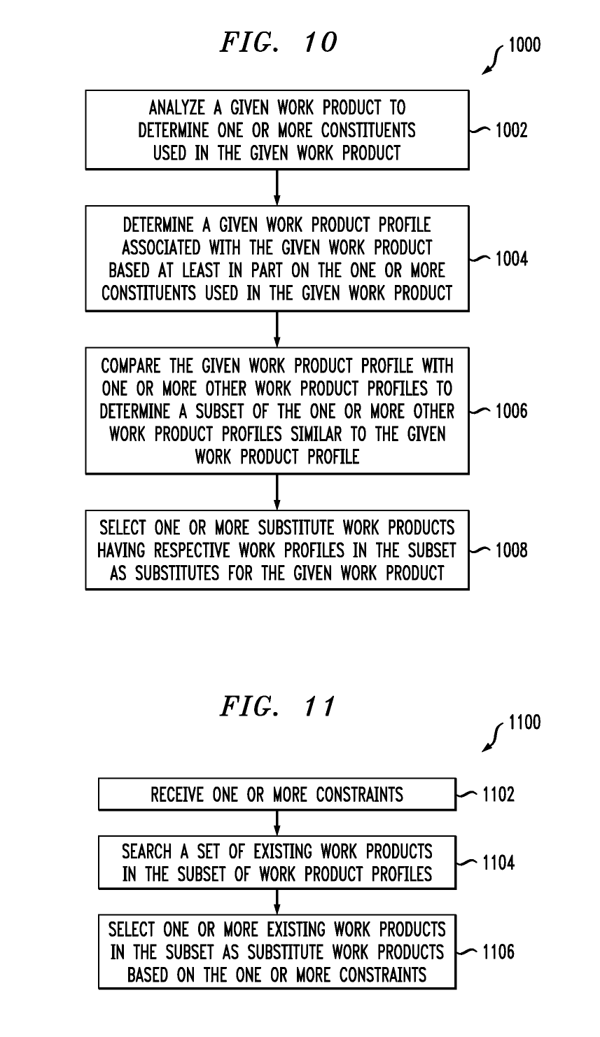

FIG. 10 illustrates a methodology 1000 for work product substitution. The methodology 1000 begins with step 1002, analyzing a given work product to determine one or more constituents used in the given work product. Step 1002 may be performed by assessor module 102 in system 100. Step 1002 may further comprise determining one or more constituent classifications associated with each constituent used in the given work product.

The methodology continues with step 1004, determining a given work product profile associated with the given work product based at least in part on the one or more constituents used in the given work product. The matching module 104 in system 100 may be utilized to perform step 1004. Step 1004 may include matching constituent classifications associated with each constituent used in the given work product to a set of constituent classifications associated with the given work product profile.

Next, the given work product profile is compared 1006 with one or more other work product profiles to determine a subset of the one or more other work product profiles which are similar to the given work product profile. Step 1006 may be performed utilizing designer module 106 of system 100. Various techniques may be used to determine similarity between work product profiles. For example, the domain knowledge database 110 may be searched for similar work profiles. Similarity may also be determined using user feedback. For example, the evaluator module 106 may utilize feedback or other data in domain knowledge database 110, as well as direct querying of users, to receive indications of similarity between work products or work product profiles.

As described above, the domain knowledge database 110 may contain a set of inspirational examples of work products associated with respective work product profiles. Work product profiles may comprise clusters of work products having similar constituents or constituent classes. Each of the work product profiles may thus comprise a set of constituent classes and corresponding characteristics for the constituent classes.

The characteristics, as described above, may include for each constituent class a frequency of occurrence of constituents in the constituent class which are used in work products associated with the work product profile or a designation of whether work products associated with the work product profile must contain one or more constituents in the constituent class or may optionally contain one or more constituents in the constituent class. The characteristics may further include, for each constituent class, respective minimum and maximum numbers of constituents in the constituent class used in work products associated with the work product profile. First and second work product profiles may be considered similar if an edit distance between characteristics of constituent classes of the first and second work product profiles is less than a specified threshold as will be described in further detail below with respect to FIG. 12.

The methodology 1000 then continues with step 1008, selecting one or more substitute work products having respective work profiles in the subset as substitutes for the given work product. In some embodiments, all possible substitute work products are selected. For example, all possible substitute work products may be provided to the evaluator module 108 in system 100. Then, based on user feedback, information regarding historical quality assessments retrieved from the domain knowledge database 110, and one or more constraints, a particular set of constituents and a corresponding substitute work product is selected as a new work product. As described above, selecting the substitute work product may include modifying an existing work product to substitute one or more constituents used in the existing work product with one or more constituents used in the given work product to generate a new work product. For example, if an omelet recipe to be substituted uses a first vegetable while a quiche recipe used as a substitute for the omelet recipe uses a second vegetable, the new work product may be a quiche recipe where the second vegetable is replaced by the first vegetable.

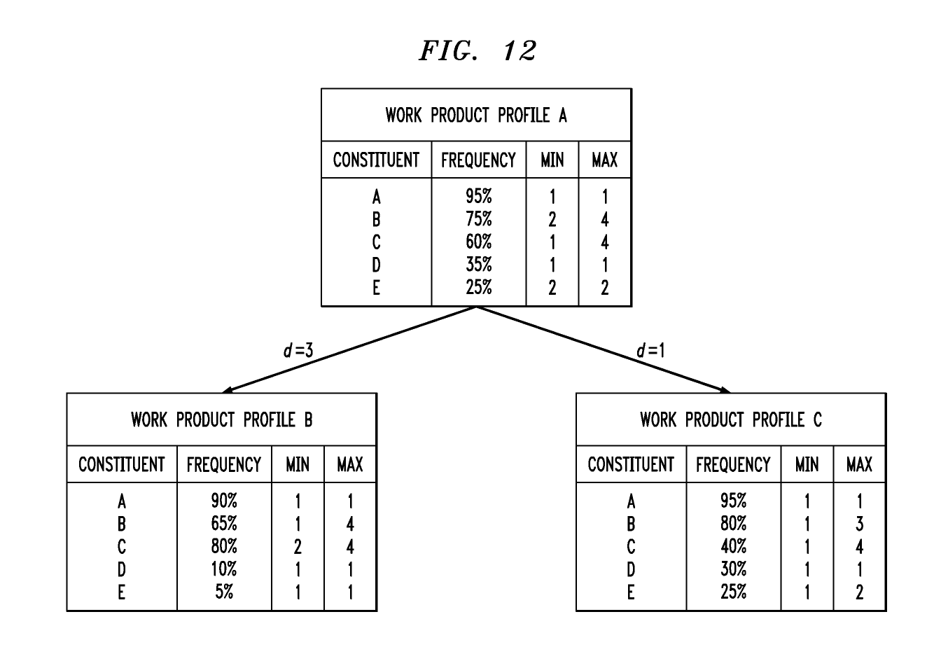

FIG. 11 illustrates a methodology 1100 of a portion of the work product substitution in methodology 1000. The methodology 1100 may be conducted in conjunction with steps 1006 and 1008 in methodology 1000. In step 1102, one or more constraints are received. Next, the methodology 1100 searches 1104 a set of existing work products in the subset of work product profiles. In some embodiments, step 1104 may involve generating one or more novel work products belonging to at least one of the subset of work product profiles. In step 1106, one or more existing work products in the subset are selected as substitute work products based on the one or more constraints. The constraints may include, by way of example, a constraint specifying one or more constituents or constituent classifications which must or must not be used in the substitute work products, a constraint specifying one or more work products which may not be selected as a substitute work product, and/or a constraint specifying one or more work product profiles which must or must not be included in the subset. The constraints may also include a constraint specifying a desired novelty level of the substitute work products relative to the given work product.

The novelty of a work product may be quantified by considering a prior probability distribution of existing work products and the change in that probability distribution after a new work product is observed, i.e., the posterior probability. As will be appreciated, novelty can be relative. For example, a substitute work product may be novel to some users but familiar to others. To achieve novelty for a particular user, the prior probability distribution may include existing work products with which the user is familiar.

In some embodiments, Bayesian surprise is utilized to calculate surprise or novelty. Let M be a set of existing work products known to an observer. Let M∈M be a work product in the set of known existing work products, and let A be a substitute work product being observed not in the set M. The Bayesian surprise can be calculated using the following equation:

$$Bayesian surprise = {\int }_{M} p ( M \vert A ) log \frac{p ( M \vert A )}{p ( M )} d M \qquad ( 1 )$$

where p denotes a probability distribution function.

The set of constraints may be determined in a number of ways. For example, some constraints may be user-defined, such as particular constituents that a user prefers to have or not have in the substitute work product. For example, a user may be preparing an existing recipe which uses meat for a group of individuals in which at least one individual is a vegetarian and/or vegan. Thus, a constraint may be that the substitute work product be vegetarian and/or vegan.

Similarly, a constraint may specify that a substitute recipe be kosher and/or halal. A user may also specify that the substitute work product only use fruits or vegetables which are in season. The user may also specify a theme for a dish, such as particular types of ethnic food dishes.

Constraints may also specify a relationship between constituents in two classes. For example, recipes may specify a particular balance between meat and vegetables, or between dairy and starches, etc.

It is important to note that the types and examples of constraints described above is not an exhaustive list of all possible constraints which may be used in embodiments of the invention. Instead, various other constraints may be used, including combinations of the constraints described herein.

FIG. 12 illustrates an example of work product profiles. For each work product profile, an association analysis algorithm can determine what constituent classes are involved in work products associated with the respective work product profiles. Statistical analysis using averages and standard deviations determine how many constituents in a given constituent class are commonly used to create work products having a given work product profile. Statistical analysis may further indicate constituents which may optionally be added. The statistical analysis may also be used to determine the substitutability of constituents within constituent classes or across two or more constituent classes. In addition, an association analysis algorithm can identify constituent classes that are frequently used together in a given work product profile. In some embodiments, the association analysis algorithm may utilize frequent-pattern (FP) trees for identifying the constituent classes frequently used together in the given work product profile.

FIG. 12 shows three work product profiles. Each work product profile A, B and C has a list of constituent classes A-E. For each constituent class, the work product profile indicates a frequency of occurrence as well as respective minimum and maximum numbers or amounts of constituents used in work products associated with the work product profile. The respective percentages associated with the frequencies of occurrence of constituent classes may in some instances be linked For example, constituents B and E may be linked such that 75% of work products in work product profile A use constituents in class B while 25% of work products in work product profile A use constituents in class E. Of course, some work products in work product profile A may include constituents in both class B and class E.

Similarity between work product profiles may be determined using an edit distance between work product profiles. The edit distance may be based in part on an insertion-deletion edit distance. As an example, if an existing dish profile calls for 10 different ingredients associated with 10 different ingredient classes, the threshold edit distance d may be 4, indicating that similar work product profiles should include at least 6 of the ingredient classes of the existing recipe and no more than 4 new ingredient classes as the existing recipe. The edit distance may alternatively be a distance based on amounts of constituents. For example, assume that an existing dish profile calls for using one pound of a given ingredient while a another dish profile calls for using only one ounce of the given ingredient. Even though the existing dish profile and the other dish profile both use the given ingredient, they may be considered dissimilar based on the respective amounts of the given ingredient commonly used in recipes associated with the respective dish profiles. In some embodiments, the threshold edit distance is based on a combination of an insertion-deletion edit distance threshold and an amount-based distance threshold.

In FIG. 12, work product profiles B and C are compared to work product profile A to determine similarity between them. The edit distance d in FIG. 12 is based on the frequencies of occurrence of the respective constituent classes. In FIG. 12, a difference of greater than 15% in the frequencies of occurrence indicates a mismatch. Thus, the distance d between work product profile A and work product profile B is 3 due to the mismatches of constituent classes C, D and E. The distance d between work product profile A and work product profile C is 1 due to the mismatch of constituent class C. It is to be appreciated that various other thresholds may be utilized for determining mismatches between constituent classes. In the FIG. 12 example, the threshold edit distance for determining similarity may be 2, such that work product profile A and C are considered similar while work product profile A and B are not considered similar. Various other threshold edit distances may be used in embodiments of the invention.

In some embodiments, constraints are used to filter work product profiles when determining similarity. For example, a fritter dish profile can be savory or sweet. A constraint may specify that a substitute recipe should be sweet to maintain harmony between a flavor profile of the existing and substitute recipes. The statistical analysis of constituent classes in the dish profile may be filtered so as to include only fritters designated as sweet. Various other constraints may be utilized to filter work product profiles when determining similarity, including the constraints described above as well as combinations of the above-described constraints.

Similarity between an existing work product and possible substitute work products may be indicated by a pair (ε, δ) where ε indicates the threshold edit distance for work product profiles and δ indicates a threshold edit distance between work products. The designer module 106 in system 100 may receive a subset of similar work product profiles, a list of constituents used in the input or existing work product, and one or more constraints. Using this information, the designer module 106 in system 100 can determine a subset of possible work product profiles using the threshold edit distance ε and one or more possible substitute work products using the threshold edit distance δ. The possible substitute work products may be further filtered using the one or more specified constraints.

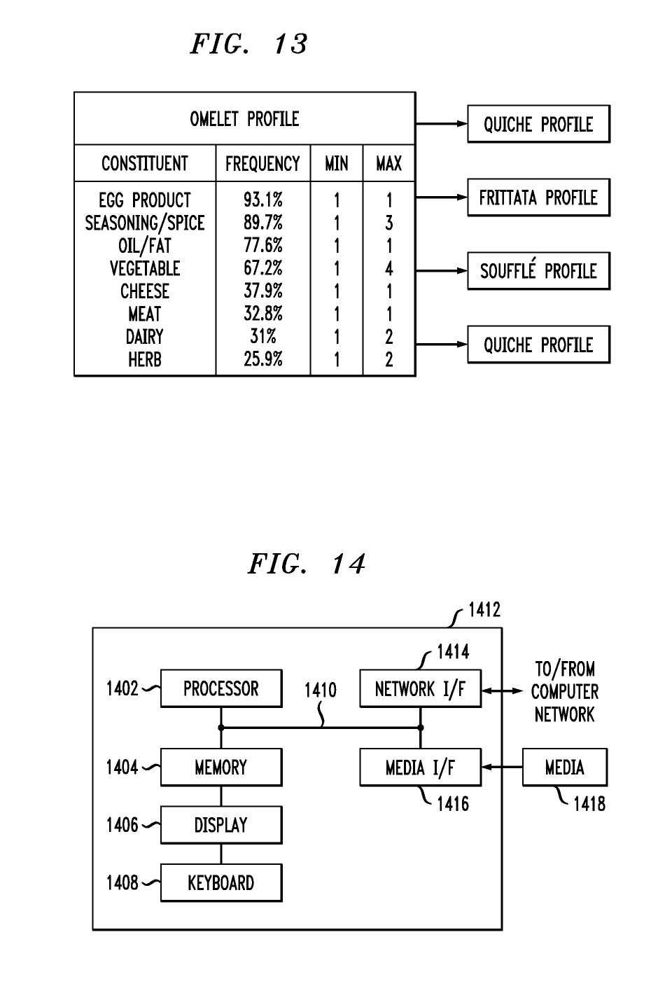

FIG. 13 illustrates a specific example of an omelet dish profile and matching between recipes. The omelet dish profile has ingredient classes of egg product, seasoning/spice, oil/fat, vegetable, cheese, meat, dairy and herb. Each ingredient class has an associated frequency of occurrence and respective minimum and maximum amounts of ingredients used in omelet recipes. FIG. 13 also shows a subset of dish profiles including the quiche, frittata, soufflé and bhurji profiles which are similar to the omelet dish profile. Given the subset of similar dish profiles, possible substitute recipes are selected based on an edit distance between ingredients used in the input recipe and the possible substitute recipes.

As an example, let the input omelet recipe be one which includes eight ingredients designated A-H. Further, let the edit distance threshold δ be an insertion/deletion edit distance threshold of 3, such that the substitute recipes must include at least five of the ingredients A-H in common with the input omelet recipe. All quiche, frittata, soufflé and bhurji recipes meeting these criteria may be selected as possible substitute recipes. The set of possible substitute recipes may be further narrowed using one or more constraints or a more detailed edit distance threshold. For example, the edit distance threshold may have two components, δ₁ and δ₂. δ₁ may be the insertion/deletion edit distance threshold of 3 described above. δ₂ may be an amount threshold, such that the respective “units” of each ingredient must be within 2 of one another. For example, the input omelet recipe may specify that three eggs are used. Thus, possible substitute recipes must include between 1 and 5 eggs. The “unit” may alternatively represent a weight or volume measure such as 2 ounces. For example, the input omelet recipe may specify that 4 ounces of diced tomatoes are included. In this example, substitute recipes must use between 2 and 6 ounces of diced tomatoes. Various other distance and/or amount thresholds may be utilized. For example, in the context of a travel itinerary the edit distance may indicate a difference between hours of operation or cost of admission for particular events. Events may also be indicated by respective suggested ages. For example, a canoe of kayaking trip may specify that the age of all participants be 13+. To maintain consistent age-appropriate events in a substitute itinerary, an age threshold may be utilized. In the context of travel itineraries, a distance threshold may also specify a geographic distance between events. As will be appreciated, numerous other types of thresholds may be selected for the application areas of recipe and itinerary substitution. Similar or other types of thresholds may be used in additional application areas.

As discussed above, constraints may be further utilized for selecting possible substitute recipes. By way of example, after determining all possible substitute recipes which meet the (ε, δ) pair describe above, the possible substitute recipes may be further filtered or narrowed down using constraints. For example, recipe constraints may specify a particular type of regional cuisine, personal tastes, dietary restrictions, etc. A subset of recipes or a particular recipe may be selected from the set of possible substitute recipes using various criteria. For example, the recipe evaluator module 208 in system 200 may evaluate the possible substitute recipes using criteria include novelty, flavor, health, user feedback, etc. in the manner described above.

It is important to note that one or more steps in FIGS. 10 and 11 and the methodologies described herein may be performed in parallel or in a different order. For example, steps 1102 and 1104 in methodology 1100 may be performed substantially simultaneously. As another example step 1104 in methodology 1100 may be performed before step 1102. Numerous other examples apply to the various steps in FIGS. 10 and 11 and the methodologies described herein.

It is to be appreciated that particular features described above with respect to a particular embodiment of the invention are not necessarily limited solely to use in the particular embodiment described. Instead, a single embodiment may include features described above in the context of two or more different embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may, be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more embodiments can make use of software running on a general purpose computer or workstation. With reference to FIG. 14, such an implementation may employ, for example, a processor 1402, a memory 1404, and an input/output interface formed, for example, by a display 1406 and a keyboard 1408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to optionally include, for example, one or more mechanisms for inputting data to the processing unit (for example, keyboard or mouse), and one or more mechanisms for providing results associated with the processing unit (for example, display or printer).

The processor 1402, memory 1404, and input/output interface such as a display 1406 and keyboard 1408 can be interconnected, for example, via bus 1410 as part of data processing unit 1412. Suitable interconnections, for example, via bus 1410, can also be provided to a network interface 1414, such as a network card, which can be provided to interface with a computer network, and to a media interface 1416, such as a diskette or CD-ROM drive, which can be provided to interface with media 1418.

A data processing system suitable for storing and/or executing program code can include at least one processor 1402 coupled directly or indirectly to memory elements 1404 through a system bus 1410. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 1408 for making data entries; display 1406 for viewing data; a pointing device for selecting data; and the like) can be coupled to the system either directly (such as via bus 1410) or through intervening I/O controllers (omitted for clarity).

Network adapters such as a network interface 1414 may also be coupled to the system to enable the data processing system to become coupled to other data processing systems or remote printers or storage devices through intervening private or public networks. Modems, cable modem and Ethernet cards are just a few of the currently available types of network adapters.

As used herein, a “server” includes a physical data processing system (for example, system 1412 as shown in FIG. 14) running a server program. It will be understood that such a physical server may or may not include a display and keyboard. Further, it is to be understood that components may be implemented on one server or on more than one server.

The flowchart and block diagrams in FIGS. 1-14 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-14, can also include, as described herein, providing a system, wherein the system includes distinct modules (e.g., modules comprising software, hardware or software and hardware).

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising the steps of:
analyzing a given work product to determine one or more constituents used in the given work product;
determining a given work product profile associated with the given work product based at least in part on the one or more constituents used in the given work product;
comparing the given work product profile with one or more other work product profiles to determine a subset of the one or more other work product profiles similar to the given work product profile; and
selecting one or more substitute work products having respective work profiles in the subset as substitutes for the given work product;
wherein the analyzing, determining, comparing and selecting steps are performed by at least one processor device.

2. The method of claim 1, wherein analyzing the given work product further comprises determining one or more constituent classifications associated with each constituent used in the given work product.

3. The method of claim 1, wherein determining the given work product profile comprises matching the constituent classifications associated with each constituent used in the given work product to a set of constituent classifications associated with the given work product profile.

4. The method of claim 1, wherein comparing the given work product profile comprises searching a domain knowledge database for the one or more other work product profiles similar to the given work product profile.

5. The method of claim 4, wherein the domain knowledge database comprises a plurality of work products associated with respective work product profiles, the work profiles comprising respective clusters of work products having similar constituents.

6. The method of claim 1, wherein each of the work product profiles comprises a set of constituent classes and corresponding characteristics.

7. The method of claim 6, wherein the characteristics comprise, for each constituent class, a frequency of occurrence of constituents in the constituent class which are used in work products associated with the work product profile.

8. The method of claim 6, wherein the characteristics comprise, for each constituent class, a designation of whether work products associated with the work product profile must contain one or more constituents in the constituent class or may optionally contain one or more constituents in the constituent class.

9. The method of claim 6, wherein the characteristics comprise, for each constituent class, respective minimum and maximum numbers of constituents in the constituent class used in work products associated with the work product profile.

10. The method of claim 6, wherein comparing the given work product profile with one or more other work product profiles comprises calculating an edit distance between characteristics of constituent classes in the given work product profile with characteristics of constituent classes in the one or more other work product profiles.

11. The method of claim 10, wherein similarity between the given work product profile and one or more other work product profiles is based on a threshold edit distance.

12. The method of claim 1, wherein selecting one or more substitute work products comprises selecting an existing work product having a work profile in the subset.

13. The method of claim 12, wherein selecting the existing work product further comprises modifying the existing work product to substitute one or more constituents used in the existing work product with one or more constituents used in the given work product to generate a new work product.

14. The method of claim 1, further comprising receiving one or more constraints related to one or more constituents in the given work product and wherein selecting the one or more substitute work products is based at least in part on the one or more constraints.

15. The method of claim 14, wherein the one or more constraints comprise:
a constraint specifying one or more constituents or constituent classifications which must or must not be used in the substitute work products;
a constraint specifying one or more work products which may not be selected as a substitute work product; and
a constraint specifying one or more work product profiles which must or must not be included in the subset.

16. The method of claim 14, wherein the one or more constraints comprise a constraint specifying a desired novelty level of the substitute work products relative to the given work product.

17. The method of claim 1, wherein the given work product comprises a recipe and the one or more constituents comprise ingredients in the recipe.

18. The method of claim 1, wherein the given work product comprises an itinerary and the one or more constituents comprise events in the itinerary.

19. An article of manufacture comprising a computer readable storage medium for storing computer readable program code which, when executed, causes a computer to:
analyze a given work product to determine one or more constituents used in the given work product;
determine a given work product profile associated with the given work product based at least in part on the one or more constituents used in the given work product;
compare the given work product profile with one or more other work product profiles to determine a subset of the one or more other work product profiles similar to the given work product profile; and
select one or more substitute work products having respective work profiles in the subset as substitutes for the given work product.

20. An apparatus comprising:
a memory; and
a processor device operatively coupled to the memory and configured to:
analyze a given work product to determine one or more constituents used in the given work product;
determine a given work product profile associated with the given work product based at least in part on the one or more constituents used in the given work product;
compare the given work product profile with one or more other work product profiles to determine a subset of the one or more other work product profiles similar to the given work product profile; and
select one or more substitute work products having respective work profiles in the subset as substitutes for the given work product.
